(19) United States
(12) Patent Application Publication
(10) Pub. No.: US 2010/0046513 A1
(43) Pub. Date: Feb. 25, 2010

(54) SYSTEM FOR AND METHOD OF PROVIDING IPTV SERVICE IN NEXT GENERATION NETWORK

(76) Inventors: Heuk Park, Daejeon-city (KR); Kyung-Gyu Jeon, Daejeon-city (KR); Soon-Seok Lee, Daejeon-city (KR); Jong-Tae Song, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/516,088

(22) PCT Filed: Oct. 31, 2007
(86) PCT No.: PCT/KR2007/005471

§ 371 Date: May 22, 2009

(30) Foreign Application Priority Data
Dec. 8, 2006 (KR) 10-2006-0125047

(51) Int. Cl. H04L 12/56

(52) U.S. Cl. 370/390; 725/109

(57) ABSTRACT

A system for and a method of providing IPTV service in a next generation network are provided. The system includes a service control unit, a transmission control unit, and an L2 switch unit. A service control unit authenticates a user terminal by receiving a request for providing a service from the user terminal which desires to receive the IPTV service and search for subscription information including the IPTV service for which the user has watching authority, when the user is an IPTV service subscriber. A transmission control unit extracts identification information of the user and a multicast address through which the IPTV service is provided from the subscription information found by the service control unit. An L2 switch unit performs switching so as to connect the multicast router which provides the IPTV service to the user terminal by identifying the watching authority of the user for the IPTV service corresponding to the request of the user terminal for providing the service by using the identification information and the multicast address through which the IPTV service provided, which are extracted by the transmission control unit.

### TECHNICAL FIELD

The present invention relates to a system for and a method of providing Internet protocol television (IPTV) service in a next generation network, and more particularly, to a functional structure for providing multicast service, and more specifically, for broadcasting IPTV service in a next generation network.

This work was party supported by the IT R&D program of MIC/IITA

### [2006-S-064-01, BcN Network Engineering]

### BACKGROUND ART

Multicast communication is a one-to-many communication technique in which a transmitter transmits the same information to a plurality of receivers. In a core network for multicast communication, a distribution tree is generally constructed by using a multicast routing protocol such as a protocol independent multicast-sparse mode (PIM-SM) protocol. In an access network, a receiver group is managed using an Internet group management protocol (IGMP).

The IGMP is a protocol for an IP layer to collectively manage the receivers. An edge router mainly manages the receivers by using the IGMP. In order to manage the receiver group, a GARP multicast registration protocol (GMRP, GARP: generic attribute registration protocol) may be used.

An L2 switch, which constitutes an access network, recognizes a port connected to a terminal having a MAC address by MAC learning. When the terminal is subscribed to the multicast group, a frame having a multicast address as a destination address has to be transmitted to the port connected to the terminal. However, since the corresponding terminal does not use the multicast address as a transmission terminal, the L2 switch recognizes the transmitted multicast address as an unknown address and transmits the multicast address to all the ports when the frame having the multicast address as the destination address is input.

Accordingly, the multicast stream is transmitted even to a port which is not connected to the terminal that needs the multicast frame. This causes waste of bandwidths. Since unnecessary traffic occupies the access network, service quality deteriorates. In a serious case, the network is stopped.

Even when the edge router uses the IGMP, since the IGMP is the protocol for the IP layer, the IGMP is not read by the L2 switch. Accordingly, the IGMP is not directly used by the L2 switch. Accordingly, in a conventional technique, the aforementioned problems are solved by including a proxy, in which IGMP snooping can be performed in the L2 switch.

When the terminal transmits the IGMP packet, the IGMP proxy updates a filtering database according to contents of the frame after snatching and reading an IGMP packet. That is, when the IGMP packet is a join request with respect to a specific multicast group (a receive request with respect to a multicast stream), the join request is recorded in the filtering database so that the frame having the multicast address as the destination address is transmitted to the port connected to the terminal which transmits the IGMP join request.

When the IGMP packet is a leave request (a receive stop request with respect to the multicast stream), the port connected to the terminal which transmits the request is deleted in the filtering database.

In the conventional technique, it is determined whether the multicast stream is received or not on the basis of only the contents of the IGMP packet. Accordingly, many problems may occur.

FIG. 1 shows a structure of a system for providing IPTV service using existing multicast service. For example, when a user watches an IPTV program on a specific IPTV channel 160 via a user terminal 110, the corresponding multicast stream is downloaded to the L2 switch 140.

When a user terminal 120 requests the IPTV program to be transmitted through the IGMP or GMRP with respect to the same channel, the L2 and L3 switches 130 and 140 copy a multicast stream 160 and download the multicast stream 160 to the user terminal 120.

Accordingly, there is provided a method in which a not authorized watcher can watch the IPTV program through the IPTV channel. In addition, this may be used as an attack for deteriorating network performance.

When a plurality of terminals concurrently transmit successive approval requests with respect to a plurality of channels to the network to which a plurality of users are connected due to a virus, and when this is not prevented, the network is filled with unnecessary data.

In FIG. 1, when the malicious user terminal 120 requests an IPTV service provider 150 to transmit the multicast stream 160, the multicast stream 160 occupies a bandwidth in a section between the L2 and L3 switches 130 and 140.

When there is no request of the watcher for the multicast stream 160 in the section, the bandwidth is wasted. Accordingly, this interrupts other service. This section may be stopped, when the plurality of terminals successively transmits approval requests with respect to all the channels.

In addition, in the conventional technique, since the L2 switch independently performs the IGMP snooping, it is impossible to gather information on watching patterns of the users. In the IPTV service, it is possible to obtain a profit model such as a custom advertisement, or a linkage of a program rating to advertisement rates.

Thus, there is a need to recognize the responses of the watchers to the contents of the broadcasting program and the advertisement in this model. It is also needed to recognize the responses by recognizing the record in the IGMP, join, and leave requests in the network.

The data corresponds to a real time complete survey record. Currently, the data depends on a sampling survey, telephone survey, or real time survey with respect to sample households.

### DISCLOSURE OF INVENTION

### Technical Problem

The present invention provides a functional structure capable of providing management of members of multicast group, which was independently performed in an existing L2 switch, within the framework of a next generation network. The functional structure can be applied to real time broadcasting service of an IPTV.

The present invention also provides a function of limiting an access of a not authorized user terminal and a function of gathering and maintaining records with respect to watching patterns of a user.

The present invention also provides a method of controlling an access in an L2 switch of an access network. In the method, information on service usage situation, which is needed for exact calculation of a network and for providing service, is gathered and provided to necessary places.

### Technical Solution

According to an aspect to the present invention, there is provided a system for providing IPTV service in a next generation network, the system comprising: a service control unit which authenticates a user terminal by receiving a request for providing a service from the user terminal which desires to receive the IPTV service and searches for subscription information including the IPTV service for which the user has watching authority, when the user is an IPTV service subscriber; a transmission control unit which extracts identification information of the user and a multicast address through which the IPTV service is provided, from the subscription information found by the service control unit; and an L2 switch unit which performs switching so as to connect the multicast router which provides the IPTV service to the user terminal by identifying the watching authority of the user for the IPTV service corresponding to the request of the user terminal for providing the service by using the identification information and the multicast address through which the IPTV service provided, which are extracted by the transmission control unit.

According to another aspect to the present invention, there is provided a method of providing IPTV service in a next generation network, the method comprising: (a) authenticating a user terminal by receiving a request for providing a service from the user terminal which desires to receive the IPTV service when the user is an IPTV service subscriber; (b) searching for subscription information including the IPTV service for which the user has watching authority; (c) extracting the user identification information and a multicast address through which the IPTV service is provided from the found subscription information; (d) performing switching so as to connect the multicast frame which provides the IPTV service to the user terminal by checking the watching authority of the user for the IPTV service corresponding to the request of the user terminal for providing service by using the identification information and the multicast address through which the IPTV service provided, which are extracted by the transmission control unit; and (e) storing the user identification information and a state of the IP service request with respect to the request of the user.

According to another aspect to the present invention, there is provided a method of providing IPTV service through a multicast router in a next generation network, the method comprising: storing subscription information including user identification information, the IPTV service which is desired to be provided, quality information of the IPTV service and authenticating the user as an IPTV service subscriber, when a user terminal which desires to receive IPTV service is requested to provide the IPTV service; authenticating the user terminal by receiving a request for providing a service from the user terminal which desires to receive the IPTV service, when the user is the IPTV service subscriber; searching for the subscription information including the IPTV service for which the user has watching authority; extracting the user identification information and a multicast address through which the IPTV service is provided from the found subscription information; separately storing the multicast addresses through which the IPTV service is provided according to users by using the extracted user identification information and the extracted multicast address through which the IPTV service is provided; checking whether the user has the watching authority with respect to the IPTV service in correspondence with the request of the user terminal for providing the service and the user identification information and the multicast address through which the IPTV service is provided, when the user terminal requests the IPTV service to be provided; transmitting a multicast frame in which the IPTV service is provided to the user terminal when it is checked that the user has the watching authority; and storing request state information of the user including information on whether the user who requests the service to be provided has the watching authority, the user identification information, the multicast address through which the requested IPTV service is provided, and a request time.

### ADVANTAGEOUS EFFECTS

As described above, there is provided the method of controlling an access of a receiver by using service subscription information when the multicast service is provided.

In addition, when a receive request of a user having no receiving authority is not limited, a broadcasting service may be allowed to be transmitted to the receiver who does not pay for the broadcasting service. When the receiver intends to attack the broadcasting service, non-profitable traffic occupies bandwidths of the network, and resources are wasted. In a serious case, the network is stopped. The present invention provides a method of preventing the network from being stopped due to the aforementioned problem.

In addition, receiving patterns of the user can be recognized by including a function of recording a receive request of the user and an accept situation. Thus, it is possible to supervise the receiving attempt of the not authorized user and the receive request having an attack intention.

In addition, in the present invention, it is possible to provide data from which the user responses to broadcasting service and an advertisement can be recognized. It is also possible to provide data from which inclination of watchers as consumers can be recognized in linkage with an information search and a purchasing record. The recognition of the inclination of the watchers allows a new profit model such as a custom advertisement for each person to be created. T-commerce as one of IPTV service models includes service for providing a method of searching for information and purchasing a product by clicking the product exposed to the broadcasting content and the advertised product.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

### DESCRIPTION OF DRAWINGS

The above and other features and advantages of the present invention will become more apparent by describing in detail exemplary embodiments thereof with reference to the attached drawings in which:

FIG. 1 shows a structure of a system for providing IPTV service using conventional multicast service;

FIG. 2 shows a structure of a system for providing IPTV service using multicast service according to an exemplary embodiment of the present invention;

FIG. 3 shows components driven when a user terminal initially accesses a system for providing IPTV service according to an exemplary embodiment of the present invention;

FIG. 4 shows a table in which user information according to an exemplary embodiment of the present invention is recorded;

FIG. 5 shows a schematic structure of components driven on the basis on user information on a system for providing IPTV service according to an exemplary embodiment of the present invention;

FIG. 6 shows a schematic structure of a system for providing IPTV service according to an exemplary embodiment of the present invention; and

FIG. 7 shows a detailed structure of an L2 switch shown in FIG. 6 according to an exemplary embodiment of the present invention.

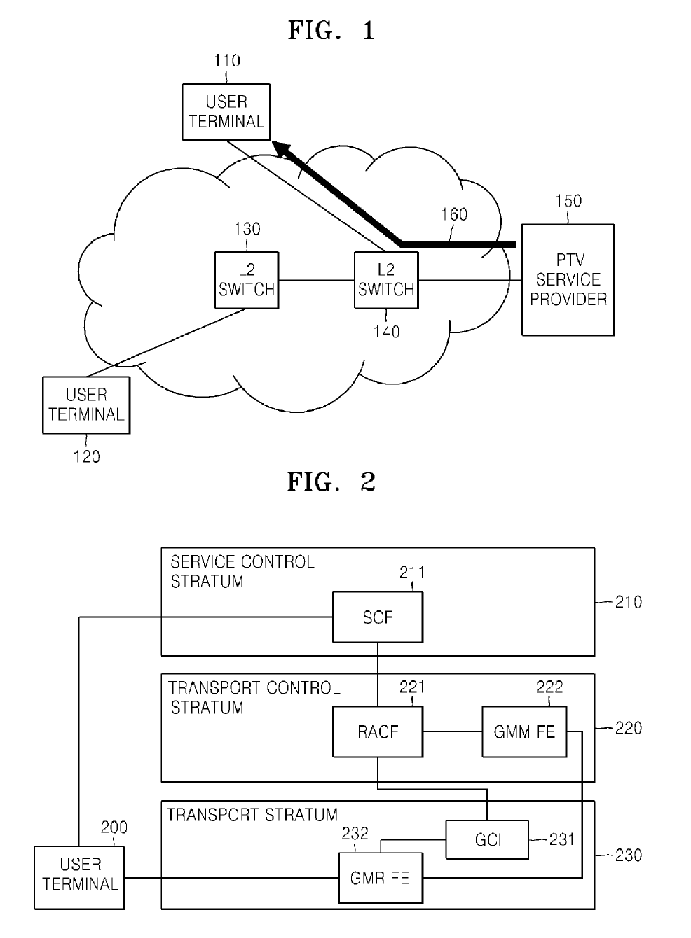

### BEST MODE

According to an aspect to the present invention, there is provided a system for providing IPTV service in a next generation network, the system comprising: a service control unit which authenticates a user terminal by receiving a request for providing a service from the user terminal which desires to receive the IPTV service and searches for subscription information including the IPTV service for which the user has watching authority, when the user is an IPTV service subscriber; a transmission control unit which extracts identification information of the user and a multicast address through which the IPTV service is provided, from the subscription information found by the service control unit; and an L2 switch unit which performs switching so as to connect the multicast router which provides the IPTV service to the user terminal by identifying the watching authority of the user for the IPTV service corresponding to the request of the user terminal for providing the service by using the identification information and the multicast address through which the IPTV service provided, which are extracted by the transmission control unit.

In the above aspect of the present invention, the service control unit may include an authentication unit which stores the subscription information including the user identification information, the IPTV service which is desired to be provided, quality information of the IPTV service and authenticates the user as an IPTV service subscriber, when the authentication unit is requested to provide a service by the user terminal which desires to receive the IPTV service.

In addition, the transmission control unit may include a requested information processing unit which collates and stores information on a request for receiving the multicast service provided by the L2 switch unit, which is channel request information.

In addition, the request information processing unit receives and stores the request information with respect to the IPTV service requested by a subscriber in the L2 switch unit. The request information includes the identification information of the subscriber, the multicast address corresponding to the requested IPTV service, a request time, and information on whether the subscriber is authorized with respect to the requested service. When service is provided with respect to a request of the subscriber having authority in the L2 switch and even when the multicast router is maintained so that the multicast router which provides the IPTV service is not connected to the user terminal since there is no watching authority of the user with respect to the IPTV service corresponding to the request for providing the service of the user terminal, subscription information of the user having no watching authority or information on the terminal of the user having no watching authority.

In addition, the L2 switch unit may comprise: a subscription information storage unit which stores the identification information of the user and the multicast address provided the IPTV service, which are extracted by the transmission control unit; a service request approval unit which checks whether the user has the watching authority with respect to the IPTV service in correspondence with the request of the user terminal for providing the service and transmits the check result to the transmission control unit, and the identification information of the user and the multicast address provided the IPTV service stored in the subscription information storage unit, when the user terminal requests the IPTV service to be provided; and a switch control unit which connects a multicast frame, which provides the IPTV service to the user terminal when it is checked by the service request approval unit that the user has the watching authority.

In addition, the subscription information may include the user identification information, the multicast address through which the IPTV service for which the user has the watching authority, and the maximum number of available multicasts of the user.

In addition, the user identification information may include a MAC address, IP address, or information obtained by matching the MAC address with the IP address of the user terminal.

According to another aspect to the present invention, there is provided a method of providing IPTV service in a next generation network, the method comprising: (a) authenticating a user terminal by receiving a request for providing a service from the user terminal which desires to receive the IPTV service when the user is an IPTV service subscriber; (b) searching for subscription information including the IPTV service for which the user has watching authority; (c) extracting the user identification information and a multicast address through which the IPTV service is provided from the found subscription information; (d) performing switching so as to connect the multicast frame which provides the IPTV service to the user terminal by checking the watching authority of the user for the IPTV service corresponding to the request of the user terminal for providing service by using the identification information and the multicast address through which the IPTV service provided, which are extracted by the transmission control unit; and (e) storing the user identification information and a state of the IP service request with respect to the request of the user.

In the above aspect of the present invention, (a) may comprise storing the subscription information including the user identification information and the IPTV service which is desired to be provided, and authenticating the user as an IPTV service subscriber when the user terminal which desires to receive the IPTV service requests to provide service.

In addition, in (e), request information with respect to the IPTV service requested by the subscriber which is obtained in (d) is received and stored. The request information includes the identification information of the subscriber, the multicast address corresponding to the requested IPTV service, a request time, and information on whether the subscriber is authorized with respect to the requested service. In (d), when the IPTV service is provided to the user since the user has the watching authority with respect to the IPTV service in correspondence with the request for providing the service of the user terminal, and even when the multicast frame is maintained so that the multicast frame in which the IPTV service is provided is not transmitted, the subscription information of the user or information on the user terminal for which the user has no watching authority is stored.

In addition, (d) may comprise: storing the user identification information and the multicast address provided the IPTV service, which are extracted in (c), checking whether the user has the watching authority with respect to the IPTV service in correspondence with the request of the user terminal for providing the service and the user identification information, and the multicast address through which the IPTV service is provided, when the user terminal requests the IPTV service to be provided; and connecting a multicast frame, which provides the IPTV service, to the user terminal when it is checked that the user has the watching authority.

According to another aspect to the present invention, there is provided a method of providing IPTV service through a multicast router in a next generation network, the method comprising: storing subscription information including user identification information, the IPTV service which is desired to be provided, quality information of the IPTV service and authenticating the user as an IPTV service subscriber, when a user terminal which desires to receive IPTV service is requested to provide the IPTV service; authenticating the user terminal by receiving a request for providing a service from the user terminal which desires to receive the IPTV service, when the user is the IPTV service subscriber; searching for the subscription information including the IPTV service for which the user has watching authority; extracting the user identification information and a multicast address through which the IPTV service is provided from the found subscription information; separately storing the multicast addresses through which the IPTV service is provided according to users by using the extracted user identification information and the extracted multicast address through which the IPTV service is provided; checking whether the user has the watching authority with respect to the IPTV service in correspondence with the request of the user terminal for providing the service and the user identification information and the multicast address through which the IPTV service is provided, when the user terminal requests the IPTV service to be provided; transmitting a multicast frame in which the IPTV service is provided to the user terminal when it is checked that the user has the watching authority; and storing request state information of the user including information on whether the user who requests the service to be provided has the watching authority, the user identification information, the multicast address through which the requested IPTV service is provided, and a request time.

### MODE FOR INVENTION

Hereinafter, preferred embodiments of the present invention will be described in detail with reference to the attached drawings.

FIG. 2 shows a structure of a system for providing IPTV service using multicast service according to an exemplary embodiment of the present invention. Referring to FIG. 2, a next generation network (NGN) includes a service control stratum 210, a transport control stratum 220, and a transport stratum 230 by separating service from transport.

A service control functional entity (SCF) 211 and resource and admission control functional entities 221 are previously determined in an existing NGN.

A group membership management functional entity (GMM FE) 222, a group membership registration functional entity (GMR FE) 232, and gate control information (GCI) 231 are newly defined in the present invention for the multicast service. The names of the newly defined functional entities may be changed.

The SCF 211 provides a signaling function for a terminal and transmits a QoS request to the transport stratum 230.

The RACF 221 provides an access control function by controlling resources of a network.

The GMM FE 222 collects and processes subscription information of a user with respect to a multicast group. The GMR FE 222 processes a request for a change of channels, a request for subscription to a multicast group or request for termination of subscription of the user.

When an Internet group management protocol (IGMP) is used, an IGMP proxy of an L2 switch and an IGMP process of an edge router correspond to the aforementioned process.

The GCI 231 is a functional entity including watching authority information of a user.

For the multicast service, and more specifically real-time broadcasting service of an IPTV, functions of SCF 211 and RACF 221 have to be extended. The SCF 211 has to transmit information on a channel of which watching authority is included in the user to the RACF 221 by referring to a service subscription situation of the user, when the user terminal 200 requests IPTV service to be provided.

At this time, information on the QoS may be transmitted together with the information on the channel. Alternatively, the information on the QoS may be previously included in the transport control stratum. The RACF 221 transmits the information on the watching authority of the user to the GCI 231 in a type of a user ID and a multicast address.

When the user terminal 200 requests the GMR FE 232 to receive a channel by using the IGMP or GMRP, the GMR FE 232 processes the request with reference to the GCI 231.

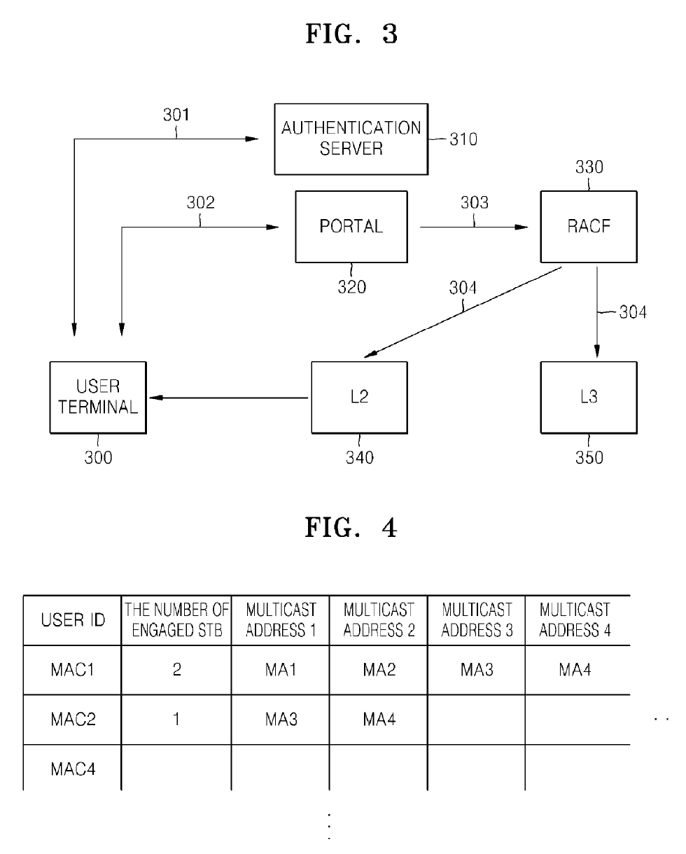

FIG. 3 shows components driven when a user terminal initially accesses a system for providing IPTV service according to an exemplary embodiment of the present invention. Referring to FIG. 3, the components driven when the user terminal initially accesses the system include an authentication server 310, a portal 320, a RACF 330, L2 switch 340, and L3 switch.

A user terminal 300 and a user are firstly authenticated (operation 301) by the authentication server 310 so that the user terminal 300 initially receives service. The a uthenticated terminal is authorized to use the service by a service portal or IPTV portal 320 (operation 302).

The IPTV service portal 320 transmits information 303 on the service, to which the user subscribes, to the RACF 330. More preferentially, the function may be performed by a policy decision functional entity (PD FE) in the RACF.

The RACF 330 transmits information 304 on the receiving authority of the user to the L2 and L3 switches 340 and 350.

Switching occurs in the L2 switch 340 so as to allow the IPTV service, which the user is authorized to receive, to be transmitted to the user terminal 300.

FIG. 4 shows a table in which user information according to an exemplary embodiment of the present invention is recorded. FIG. 4 shows an example of information 304 on the receiving authority of the user of FIG. 3.

A MAC address or an IP address may be used as a user ID. In the information transmitted to the L2 switch, the MAC address may be used as the ID. In the information transmitted to the L3 switch, the IP address may be used as the ID. Alternatively, the MAC address and the IP address may be used as the ID.

A multicast address is a multicast address of a channel on which the user has the receiving authority. In addition, as shown in FIG. 4, the number of the set-top boxes (STBs) for which the user makes a contract or the number of the channels through which the user can watch the contents may be provided.

The information is used to limit sharing the authority registered by using the address of the user among a plurality of STBs. Registration is performed only in a household or STB, and however the authority is shared by a plurality of households or STBs. The service provider provides contents for free.

This function is used to limit an access of a user who desires to receive the service without charge. Even when a home gateway instead of the STB requests a channel to be changed, this function is usefully used.

In order to use this function, an increase of the total stream number and processing of a sub screen due to an instantaneous change of a channel have to be considered.

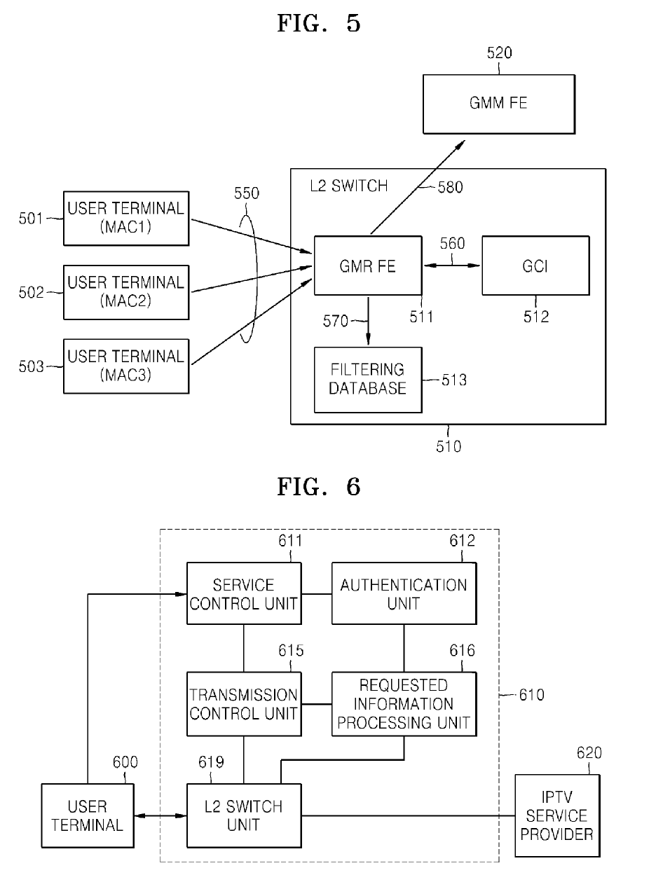

FIG. 5 shows a schematic structure of components driven on the basis on user information on a system for providing IPTV service according to an exemplary embodiment of the present invention. Referring to FIG. 5, the components driven on the basis of the user information include an L2 switch 510 and a GMM FE 520.

It is assumed that a GCI 512 includes the information of FIG. 4. The MAC addresses of three user terminals 501 to 503 are MAC1, MAC2, and MAC3, respectively. When the three terminals transmit a join request with respect to a multicast address MA1, the join request is processed by the GMR FE 520.

When the three user terminals do not receive the MA1, the GMR FE 511 refers to data 560 of the GCI 512 with respect to this request. In FIG. 4, the user terminal 501 of which ID is MAC1 has an authority to receive the multicast address MAC1, and the user terminal 502 of which ID is MAC2 does not have an authority to receive the address MA1 in the subscribed service.

It is known that the user terminal 503 of which ID is MAC3 is a user who is not approved for the service. Accordingly, the GMR FE 511 updates a filtering database 513 so as to transmit a multicast frame having the MA1 address with respect to only the user 501 of which ID is MAC1 (operation 570).

After the request is processed, the GMR FE 511 transmits information 580 on the request to the GMM FE 520. The information 580 may include the request situation for an approval with respect to a not authorized user in addition to a connection of an authorized user.

Information on the authorized user may be used for exact calculation, program rating data, and recognizing a viewer inclination. Information on the not authorized user may be used to supervise watching with respect to channels which are not approved and supervise the approval request which intends to attack the network.

The information 580 may be transmitted in real time, not in real time, or at a predetermined time interval.

FIG. 6 shows a schematic structure of a system for providing IPTV service according to an exemplary embodiment of the present invention. Referring to FIG. 6, a system 610 for providing IPTV service includes a service control unit 611, an authentication unit 612, a transmission control unit 615, a request information processing unit 616, and an L2 switch unit 619.

The service control unit 611 authenticates the user terminal by receiving the request for providing a service from the user terminal which desires to receive the IPTV service and searches for the subscription information including the IPTV service for which the user has the watching authority, when the user is an IPTV service subscriber.

When the authentication unit 612 is requested to provide a service by the user terminal which desires to receive the IPTV service, the authentication unit 612 stores the subscription information including the user identification information, the IPTV service which is desired to be provided, quality information of the IPTV service and authenticates the user as the IPTV service subscriber.

The transmission control unit 615 extracts the identification information of the user and the multicast address through which the IPTV service is provided, from the subscription information found by the service control unit.

The L2 switch unit 619 identifies the watching authority of the user for the IPTV service corresponding to the request of the user terminal for providing the service, by using the identification information and the multicast address through which the IPTV service provided, which are extracted by the transmission control unit, and performs switching so as to connect the multicast router which provides the IPTV service to the user terminal. The L2 switch unit 619 transmits the request information of the user terminal including the identification information of the user, the multicast address through which the IPTV service is provided, a request time, and the authority for the service with respect to the user, who requests the service to be provided, to the request information processing unit 161.

The requested information processing unit 616 receives and stores user request state information such as the identification information of the user who requests the service provided by the L2 switch unit 619 to be provided, a multicast address, and a request time. The request information processing unit 616 transmits the information to other functional entries which needs the information. The information of the authorized user with respect to the IPTV service may be used for an exact calculation, user statistics, and the like. The information of the not authorized user may be used for supervision of a network.

When a user terminal 600 requests the service control unit 611 to provide a service, the service control unit 611 connects the IPTV service provider 620 to the user terminal 600 after the authority to use the service is verified through the system 610 for providing the IPTV service. When the multicast address through which the IPTV service is transmitted previously exists in the filtering database of the L2 switch unit 619, and when a port, which is connected to the user who requests the IPTV service provider 620 to be connected to the user terminal 600, is not registered as a destination of the multicast address, the aforementioned connection between the IPTV service provider 620 and the user terminal 600 is obtained by adding a port connected to the user to the destination port of the multicast address of the filtering database so that a frame including the multicast address is transmitted to the port connected to the user terminal. When the multicast address is not registered in the filtering database of the L2 switch unit 619, the aforementioned connection between the IPTV service provider 620 and the user terminal 600 is obtained by adding a port connected to the user to the multicast address and the destination port of the filtering database and transmitting an IGMP message to an IGMP Querier. The service is disconnected by deleting the port connected to a user who requests the destination port of the multicast address to be disconnected from the port. At this time, it can be checked whether other users exist in the same port according to procedures of IGMP or GMRP protocol.

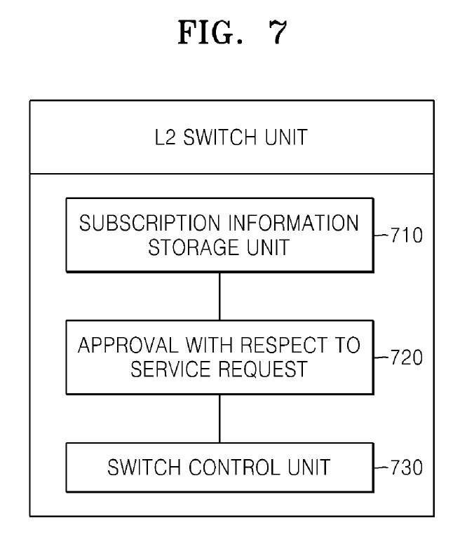

FIG. 7 shows a detailed structure of an L2 switch shown in FIG. 6 according to an exemplary embodiment of the present invention. Referring to FIG. 7, the L2 switch unit includes a subscription information storage unit 710, a service request approval unit 720, and a switch control unit 730.

The subscription information storage unit 710 stores the multicast address through which the IPTV service authorized with respect to users and identification information of the user, which are extracted by the transmission control unit, are provided.

When the user terminal requests the IPTV service to be provided, the service request approval unit 720 checks whether the user has the watching authority with respect to the IPTV service in correspondence with the identification information of the user stored in the subscription information storage unit, the multicast address through which the IPTV service is provided, and the request of the user terminal for providing the service.

When it is checked by the service request approval unit whether the user has watching authority, the switch control unit 730 connects a multicast router, which provides the IPTV service, to the user terminal.

While the present invention has been particularly shown and described with reference to exemplary embodiments thereof, it will be understood by those skilled in the art that various changes in form and details may be made therein without departing from the spirit and scope of the present invention as defined by the appended claims.

1. A system for providing IPTV service in a next generation network, the system comprising:
a service control unit which authenticates a user terminal by receiving a request for providing a service from the user terminal which desires to receive the IPTV service and searches for subscription information including the IPTV service for which the user has watching authority, when the user is an IPTV service subscriber;
a transmission control unit which extracts identification information of the user and a multicast address through which the IPTV service is provided, from the subscription information found by the service control unit; and
an L2 switch unit which performs switching so as to connect the multicast router which provides the IPTV service to the user terminal by identifying the watching authority of the user for the IPTV service corresponding to the request of the user terminal for providing the service by using the identification information and the multicast address through which the IPTV service provided, which are extracted by the transmission control unit.

2. The system of claim 1, wherein the service control unit includes an authentication unit which stores the subscription information including the user identification information, the IPTV service which is desired to be provided, quality information of the IPTV service and authenticates the user as an IPTV service subscriber, when the authentication unit is requested to provide a service by the user terminal which desires to receive the IPTV service.

3. The system of claim 1, wherein the transmission control unit includes a requested information processing unit which receives user request state information including the identification information of the user who requests the service to be provided, a multicast address, and a request time from the L2 switch unit and separately stores the user request state information according to watching authorities and users.

4. The system of claim 1, wherein the L2 switch unit comprises:
a subscription information storage unit which stores the identification information of the user and the multicast address provided the IPTV service, which are extracted by the transmission control unit;
a service request approval unit which checks whether the user has the watching authority with respect to the IPTV service in correspondence with the request of the user terminal for providing the service and transmits the check result to the transmission control unit, and the identification information of the user and the multicast address provided the IPTV service stored in the subscription information storage unit, when the user terminal requests the IPTV service to be provided; and
a switch control unit which connects a multicast frame, which provides the IPTV service to the user terminal when it is checked by the service request approval unit that the user has the watching authority.

5. The system of claim 1, wherein the subscription information includes the user identification information, the multicast address through which the IPTV service for which the user has the watching authority, and the maximum number of available multicasts of the user.

6. The system of claim 1, wherein the user identification information includes a MAC address, IP address, or information obtained by matching the MAC address with the IP address of the user terminal.

7. A method of providing IPTV service in a next generation network, the method comprising:
(a) authenticating a user terminal by receiving a request for providing a service from the user terminal which desires to receive the IPTV service when the user is an IPTV service subscriber;
(b) searching for subscription information including the IPTV service for which the user has watching authority;
(c) extracting the user identification information and a multicast address through which the IPTV service is provided from the found subscription information;
(d) performing switching so as to connect the multicast frame which provides the IPTV service to the user terminal by checking the watching authority of the user for the IPTV service corresponding to the request of the user terminal for providing service by using the identification information and the multicast address through which the IPTV service provided, which are extracted by the transmission control unit; and
(e) storing the user identification information and a state of the IP service request with respect to the request of the user.

8. The method of claim 7, wherein (a) comprises storing the subscription information including the user identification information and the IPTV service which is desired to be provided, and authenticating the user as an IPTV service subscriber when the user terminal which desires to receive the IPTV service requests to provide service.

9. The method of claim 7, wherein (e) includes storing service request information including the user identification information, information on whether the service is authorized, the multicast address, and a request time, when the multicast frame is maintained so that the multicast frame in which the IPTV service is provided is not transmitted to the user terminal since there is no watching authority of the user with respect to the IPTV service corresponding to the request of the user terminal for providing the service, and when the multicast frame in which the IPTV service is provided is transmitted to the user terminal since the there is the watching authority of the user.

10. The method of claim 7, wherein (d) comprises:
storing the user identification information and the multicast address provided the IPTV service, which are extracted in (c),
checking whether the user has the watching authority with respect to the IPTV service in correspondence with the request of the user terminal for providing the service and the user identification information, and the multicast address through which the IPTV service is provided, when the user terminal requests the IPTV service to be provided; and
connecting a multicast frame, which provides the IPTV service, to the user terminal when it is checked that the user has the watching authority.

11. A method of providing IPTV service in a next generation network, the method comprising:
storing subscription information including user identification information, the IPTV service which is desired to be provided, quality information of the IPTV service and authenticating the user as an IPTV service subscriber, when a user terminal which desires to receive IPTV service is requested to provide the IPTV service;
authenticating the user terminal by receiving a request for providing a service from the user terminal which desires to receive the IPTV service, when the user is the IPTV service subscriber;
searching for the subscription information including the IPTV service for which the user has watching authority;
extracting the user identification information and a multicast address through which the IPTV service is provided from the found subscription information;
separately storing the multicast addresses through which the IPTV service is provided according to users by using the extracted user identification information and the extracted multicast address through which the IPTV service is provided;
checking whether the user has the watching authority with respect to the IPTV service in correspondence with the request of the user terminal for providing the service and the user identification information and the multicast address through which the IPTV service is provided, when the user terminal requests the IPTV service to be provided;
transmitting a multicast frame in which the IPTV service is provided to the user terminal when it is checked that the user has the watching authority; and
storing request state information of the user including information on whether the user who requests the service to be provided has the watching authority, the user identification information, the multicast address through which the requested IPTV service is provided, and a request time.
